(19) United States
(12) Patent Application Publication
(10) Pub. No.: US 2026/0363822 A1
(43) Pub. Date: Nov. 19, 2026

(54) METHOD FOR GENERATING DIGITAL DATASET REPRESENTING TARGET TOOTH ARRANGEMENT

(71) Applicant: SHANGHAI EA MEDICAL INSTRUMENTS COMPANY LIMITED, Shanghai (CN)

(72) Inventors: Mingzheng Wang, Shanghai (CN); Yang Feng, Shanghai (CN); Deming Qiao, Shanghai (CN); Jiawei Sun, Shanghai (CN)

(21) Appl. No.: 18/863,819

(22) PCT Filed: May 4, 2023
(86) PCT No.: PCT/CN2023/091996

§ 371 Date: Nov. 7, 2024

(30) Foreign Application Priority Data
May 7, 2022 (CN) 202210525768.5

(51) Int. Cl. A61C 7/00; A61C 13/34; G06T 19/20

(52) U.S. Cl. CPC A61C 7/002; A61C 13/34; G06T 19/20; G06T 2210/41; G06T 2219/2004

(57) ABSTRACT

One aspect of the present application provides a computer-implemented method for generating a digital dataset representing a target tooth arrangement, comprising: obtaining a digital 3D model of upper jaw teeth and lower jaw teeth at an initial tooth arrangement; preliminarily aligning the upper jaw teeth and lower jaw teeth separately according to given indices; calculating an optimal target tooth arrangement using an energy function based on the preliminarily aligned upper jaw teeth and lower jaw teeth.

### FIELD OF THE APPLICATION

The present application generally relates to a method for generating a digital dataset representing a target tooth arrangement.

### BACKGROUND

With rapid development of computer technologies, dental treatment increasingly relies on computer technologies, for example, dental professionals may manually reposition teeth in a 3D (3 dimensional) digital model of teeth at an initial tooth arrangement through a user interface of a dedicated computer program to obtain a 3D digital model of teeth at a target tooth arrangement.

However, the above method has the following drawbacks: (1) a beginner needs a long learning period to master how to use a computer program for 3D-aided design and medical theoretical knowledges about orthodontics; (2) as individuals' cognition and habits might vary, the normalization of obtained target tooth arrangements is poor; (3) since the operation is performed manually, it usually takes 30 minutes to 2 hours to design a target tooth arrangement for a case, the efficiency is low.

Therefore, it is necessary to provide a new method for generating a digital dataset representing a target tooth arrangement.

### SUMMARY

One aspect of the present application provides a computer-implemented method for generating a digital dataset representing a target tooth arrangement, comprising: obtaining a digital 3D model of upper jaw teeth and lower jaw teeth at an initial tooth arrangement; preliminarily aligning the upper jaw teeth and lower jaw teeth separately according to given indices; calculating an optimal target tooth arrangement using an energy function based on the preliminarily aligned 3D digital model of the upper jaw teeth and the lower jaw teeth.

In some embodiments, the target tooth arrangement may be a tooth arrangement to be achieved by an orthodontic treatment.

In some embodiments, the given indices may comprise two dental arch curves respectively calculated based on the upper jaw teeth and lower jaw teeth at the initial tooth arrangement, and the preliminary alignment may comprise repositioning the upper jaw teeth and lower jaw teeth respectively according to the two dental arch curves so that FA feature points of the teeth are located on corresponding dental arch curves.

In some embodiments, the preliminary alignment may further comprise repositioning the upper jaw teeth and lower jaw teeth repositioned according to the dental arch curves such that torques and angulations of corresponding teeth are in the same directions.

In some embodiments, the given indices may further comprise left and right Spee curves calculated based on the upper jaw teeth and lower jaw teeth at the initial tooth arrangement, and the preliminary alignment may further comprise adjusting heights of posterior teeth of the upper jaw teeth and lower jaw teeth, whose torques and angulations are adjusted, according to the Spee curves.

In some embodiments, the given indices may further comprise heights of upper jaw incisors and lower jaw incisors calculated based on the upper jaw teeth and lower jaw teeth, whose torques and angulations are adjusted, and the preliminary alignment may further comprise adjusting the heights of the incisors of the upper jaw and lower jaw, whose torques and angulations are adjusted, according to the calculated heights of the incisors.

In some embodiments, the dental arch curves may be such that after the upper jaw teeth and the lower jaw teeth are repositioned according to the dental arch curves, cutting ridges of lower jaw molars are substantially located in central grooves of upper jaw molars.

In some embodiments, the energy function may be such that the target tooth arrangement meets requirements of orthodontic treatment on the following aspects: occlusion coverage of anterior teeth, molar neutral relationship, and relationship between teeth midline and face midline.

In some embodiments, the optimal target tooth arrangement may be calculated using the energy function based on priorities of adjustment targets, degrees of difficulty of repositioning different teeth, and a total adjustment amount.

In some embodiments, the computer-implemented method for generating a digital dataset representing a target tooth arrangement may further comprise: repositioning the preliminarily aligned upper jaw teeth and lower jaw teeth to the optimal target tooth arrangement.

In some embodiments, the computer-implemented method for generating a digital dataset representing a target tooth arrangement may further comprise: allocating enamel reductions/gaps to the upper jaw teeth and lower jaw teeth at the target tooth arrangement.

In some embodiments, the computer-implemented method for generating a digital dataset representing a target tooth arrangement may further comprise: adjusting the occlusion depth of the upper jaw teeth and lower jaw teeth at the target tooth arrangement.

### BRIEF DESCRIPTION OF THE DRAWINGS

The above and other features of the present application will be further illustrated below with reference to figures and their detailed description. It should be appreciated that these figures only show several exemplary embodiments according to the present application, so they should not be construed as limiting the scope of the present application. Unless otherwise specified, the figures are not necessarily drawn to scale, and similar reference numbers therein denote similar components.

FIG. 1 illustrates a schematic flow chart of a method for generating a digital dataset representing a target tooth arrangement according to one embodiment of the present application;

FIG. 2A illustrates a 3D digital model of lower jaw teeth at an initial tooth arrangement in an example shown in one interface of a computer program for generating a digital dataset representing a target tooth arrangement according to one embodiment of the present application;

FIG. 2B illustrates a tooth arrangement after the lower jaw teeth shown in FIG. 2A are aligned according to a calculated dental arch curve and adjusted in terms of torques and angulations, shown in an interface of the computer program;

FIG. 3 illustrates a tooth arrangement after heights of posterior teeth of the upper jaw teeth and lower jaw teeth are adjusted according to calculated Spee curves, shown in an interface of the computer program;

FIG. 4 illustrates a tooth arrangement of upper jaw teeth after incisal edges of upper incisors are retracted in one example shown in one interface of the computer program.

### DETAILED DESCRIPTION OF ILLUSTRATED EMBODIMENTS

In the following detailed description, reference is made to the accompanying drawings, which form a part thereof. Exemplary embodiments in the detailed description and figures are only intended for illustration purpose and not meant to be limiting. Inspired by the present application, those skilled in the art can understand that other embodiments may be utilized and other changes may be made, without departing from the spirit or scope of the present application. It will be readily understood that aspects of the present application described and illustrated herein can be arranged, replaced, combined, separated and designed in a wide variety of different configurations, all of which are explicitly contemplated and make part of the present application.

One aspect of the present application provides a computer-implemented method for generating a digital dataset representing a target tooth arrangement, which mainly comprises two steps: first, preliminarily aligning upper jaw teeth and lower jaw teeth separately according to given indices; then, calculating an optimal target tooth arrangement using an energy function based on the preliminarily aligned upper jaw teeth and lower jaw teeth.

Another aspect of the present application provides a computer system for generating a digital dataset representing a target tooth arrangement, which comprises a processor and a memory, the memory stores a computer program for generating a digital dataset representing a target tooth arrangement, when executed, the computer program will cause the processor to implement the method for generating a digital dataset representing a target tooth arrangement.

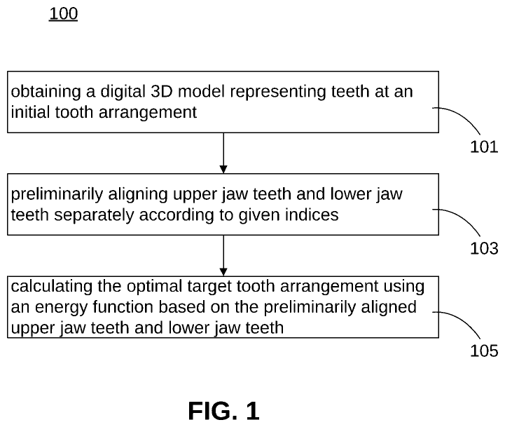

Referring to FIG. 1, it illustrates a schematic flow chart of a computer-implemented method 100 for generating a digital dataset representing a target tooth arrangement according to one embodiment of the present application.

In 101, a 3D digital model of teeth at an initial tooth arrangement is obtained.

A target tooth arrangement refers to a tooth arrangement to be achieved by an orthodontic treatment. An initial tooth arrangement refers to a patient's current tooth arrangement based on which a digital dataset representing a target tooth arrangement is generated using the method according to the present application.

In one embodiment, a digital dataset representing a target tooth arrangement may be a digital dataset representing poses (positions and postures) of teeth.

In one embodiment, the 3D digital model of teeth at the initial tooth arrangement may be obtained by directly scanning the patient's jaws. In another embodiment, the 3D digital model of teeth at the initial tooth arrangement may be obtained by scanning a physical model such as a plaster model of the patient's jaws. In a further embodiment, the 3D digital model of teeth at the initial tooth arrangement may be obtained by scanning an impression of the patient's jaws.

In one embodiment, after the 3D digital model of teeth at the initial tooth arrangement is obtained, the 3D digital model may be segmented to make teeth independent from one another so that the teeth can be repositioned individually.

The 3D digital model of teeth at the initial tooth arrangement comprises upper jaw teeth and lower jaw teeth such that in the process that the digital dataset representing the target tooth arrangement is calculated, positional relationships between the upper jaw teeth and lower jaw teeth can be taken into consideration.

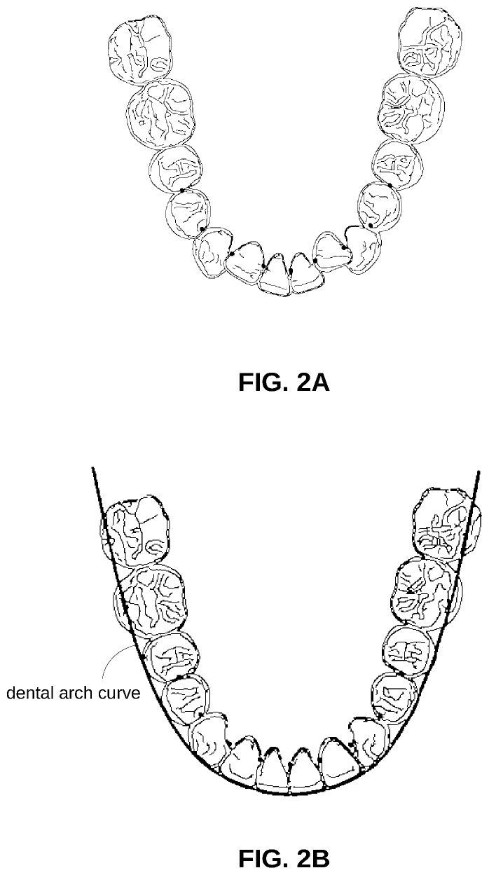

Referring to FIG. 2A, it illustrates a 3D digital model of lower jaw teeth at an initial tooth arrangement in an example shown in one interface of the computer program.

In 103, the 3D digital model of the upper jaw teeth and lower jaw teeth at the initial tooth arrangement are preliminarily aligned separately according to given indices.

After the 3D digital model of the upper jaw teeth and lower jaw teeth at the initial tooth arrangement is obtained, the upper jaw teeth and lower jaw teeth are first preliminarily aligned separately according to given indices without considering orthodontic indices which are strongly-associated with relationships between the upper and lower jaws. The preliminary alignment may be referred to as in-jaw alignment which is mainly alignment performed based on geometries and poses of the teeth within single jaws, and it mainly comprises the following operations: aligning the upper jaw teeth and lower jaw teeth respectively according to corresponding dental arch curves; repositioning the upper jaw teeth and lower jaw teeth such that torques and angulations of corresponding teeth are in the same directions; adjusting heights of posterior teeth of the upper and lower jaws according to Spee curves; and adjusting heights of incisors of the upper and lower jaws to corresponding target heights.

For ease of illustration, the operation in step 103 will be described in detail below by taking the lower jaw teeth as an example.

In one embodiment, a tooth axis direction and a FA feature point of each lower jaw tooth may be calculated based on the 3D digital model of the lower jaw teeth at the initial tooth arrangement. There are already multiple methods for calculating tooth axis direction and FA feature point in the art. Therefore, the methods will not be described in detail any more here.

Then, a dental arch curve, which is smooth, meets aesthetic requirement of tooth arrangement, and is approximate to the initial tooth arrangement, may be calculated based on the 3D digital model of the lower jaw teeth at the initial tooth arrangement. There are already multiple methods for calculating a dental arch curve in the art. Therefore, the methods will not be described in detail any more here.

Then, the poses of the teeth are adjusted in a predetermined order so that the FA feature points of the teeth are located on the dental arch curve, and the proximal-distal axis of each tooth is parallel to a line tangential to the dental arch curve at the FA feature point of the tooth.

Then, torque and angulation of each of the teeth of the 3D digital model of the lower jaw teeth aligned according to the dental arch curve are adjusted with the FA feature point of the tooth as a rotation center such that the tooth arrangement meets aesthetic requirement. For example, as for torque, reference may be made to a MBT standard, to adjust the torques of teeth #1 and #2 on the upper jaw to 17 degrees and 10 degrees, respectively; adjust the torques of teeth #1 and #2 on the lower jaw to 6 degrees; adjust the torques of the posterior teeth in a single quadrant such that they are same with each other, and the sum of differences between the initial torques and the updated torques is the smallest; adjust the torques of the canines to an average value of the torques of the posterior teeth and incisors in a corresponding quadrant. As for angulation, reference may be made to the MBT standard, to adjust the angulations of teeth #1, #2 and #3 on the upper jaw to four degrees, eight degrees and eight degrees, respectively, and adjust the angulations of teeth #1, #2 and #3 on the lower jaw to zero degrees, zero degrees and three degrees, respectively.

Referring to FIG. 2B, it illustrates a tooth arrangement shown in one interface of the computer program after the lower jaw teeth shown in FIG. 2A are aligned according to a calculated dental arch curve and adjusted in terms of torque and angulation.

Then, a Spee curve, which is smooth, meets aesthetic requirement of tooth arrangement, and is approximate to the tooth arrangement, is calculated for the posterior teeth on the left side and right side based on the 3D digital models of upper jaw teeth and lower jaw teeth at the initial tooth arrangement. There are already multiple methods for calculating a Spee curve in the art. Therefore, the methods will not be described in detail any more here.

Then, the heights of the lower jaw posterior teeth, whose angulations and torques are adjusted, are adjusted such that they match the Spee curves, i.e., the central grooves of the upper jaw posterior teeth and outside cutting ridges of the lower jaw posterior teeth are located on the Spee curves.

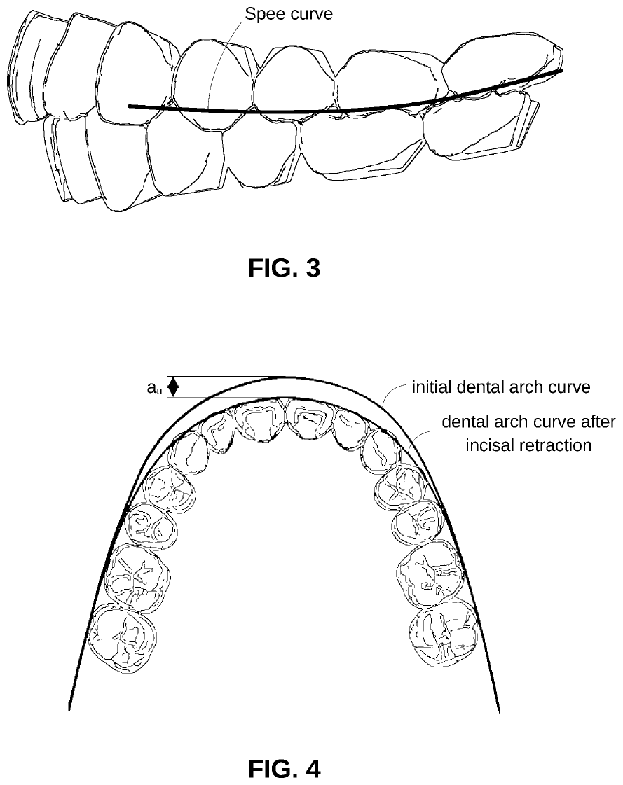

Referring to FIG. 3, it illustrates a tooth arrangement shown in an interface of the computer program after heights of posterior teeth of the upper jaw and lower jaw in one example are adjusted according to the calculated Spee curves.

Then, target heights of incisal edges of the upper jaw incisors and lower jaw incisors may be calculated, and then the heights of the incisal edges of the incisors of the 3D digital model of teeth, of which the heights of posterior teeth are adjusted according to the Spee curves, may be adjusted to the calculated target heights to obtain an in-jaw aligned 3D digital model of teeth. Two factors may be considered when calculating the target heights of the incisal edges: one is the occlusion coverage of the upper jaw anterior teeth and lower jaw posterior teeth, and the other is the height of the exposed gingiva when the patient smiles with teeth exposed.

When the patient smiles with teeth exposed, it is desirable to sufficiently expose the incisors and expose the upper jaw gingiva no more than 2 mm. Therefore, the target heights of incisal edges of the upper jaw incisors may be calculated based on the 3D model of teeth at the initial tooth arrangement and the patient's front smiling photo to make the exposed upper jaw gingiva no more than 2 mm. Then, the target heights of the incisal edges of the lower jaw incisors may be calculated based on the calculated target heights of the incisal edges of the upper jaw incisors so that overbite complies with standard, for example, 1 mm.

In orthodontic treatments, one of the requirements is a proper occlusion coverage of the upper jaw anterior teeth and lower jaw anterior teeth, wherein overbite refers to a vertical positional relationship between the incisal edges of the upper jaw anterior teeth and lower jaw posterior teeth. Usually, an overbite that the incisal edges of the upper jaw anterior teeth cover the lower jaw anterior teeth no more than ⅓ of the lengths of the crowns of the lower jaw anterior teeth, or the lower jaw anterior teeth occlude to the lingual side of the upper jaw anterior teeth less than ⅓ of the lengths of the upper jaw anterior teeth, is believed to be a normal overbite.

In one embodiment, positional relationships between the upper jaw posterior teeth and lower jaw posterior teeth may be considered when calculating the dental arch curves, so that the cutting ridges of the lower jaw posterior teeth are substantially located in the central grooves of the upper jaw posterior teeth after the 3D digital model of teeth is aligned according to the calculated dental arch curves. In this embodiment, the cutting ridge and central groove features of the upper jaw posterior teeth and lower jaw posterior teeth need to be first calculated based on the 3D digital model of teeth at the initial tooth arrangement.

The occlusion relationship between upper jaw and lower jaw posterior teeth of the in-jaw aligned 3D digital model of teeth might still fail to strictly meet some requirements. At this time, the positions of the upper jaw posterior teeth and lower jaw posterior teeth may be fine-tuned to make the occlusion relationship strictly meet the requirements.

In 105, an optimal target tooth arrangement is calculated using an energy function based on the preliminarily aligned 3D digital model of upper jaw teeth and lower jaw teeth.

The preliminarily aligned upper jaw teeth and lower jaw teeth might still fail to meet the following requirements of the orthodontic treatment: the occlusion coverage of the upper jaw anterior teeth and lower jaw anterior teeth is normal, the upper jaw molars and lower jaw molars meet a neutral relationship requirement, and the midlines of the upper jaw teeth and lower jaw teeth are aligned with the face midline. To meet the above requirements, the preliminarily aligned upper jaw teeth and lower jaw teeth may be further adjusted by the following means to achieve the target tooth arrangement: adjust the positions of the incisal edges of the upper jaw incisors and lower jaw incisors, adjust the positions the molars in the four quadrants along proximal-distal direction, and adjust the position of the midlines of the upper jaw teeth and lower jaw teeth.

The upper jaw anterior teeth and lower jaw anterior teeth can be adjusted to a proper overjet, which meets orthodontic aesthetic requirement, by adjusting the positions of the incisal edges of the upper jaw incisors and lower jaw incisors. Usually, a distance between the incisal edges of the upper jaw incisors and the labial surfaces of the lower jaw incisors of less than 3 mm is believed to be a normal overjet.

In one embodiment, the positions of the incisal edges of the upper jaw incisors and lower jaw incisors may be adjusted by changing the geometry of the dental arch curves. In one embodiment, the distance between the vertices of the adjusted dental arch curve and the vertices of the original dental arch curve may be taken as an adjustment amount of the positions of the incisal edges.

Referring to FIG. 4, it illustrates the in-jaw aligned upper jaw teeth after incisal edges of incisors are retracted in one example shown in one interface of the computer program, wherein aᵤ stands for the adjustment amount of the incisal edges of the upper jaw incisors.

In orthodontic treatments, it is desirable that the upper jaw molars and lower jaw molars are in a neutral relationship, i.e., the proximal buccal cusps of teeth #6 on the upper jaw are located in the proximal buccal grooves of teeth #6 on the lower jaw in the occluded state. The target can be achieved by adjusting the positions of the upper jaw molars and lower jaw molars along proximal-distal direction.

In an ideal case, it is desirable that the midlines of the upper jaw teeth and lower jaw teeth are aligned or substantially aligned with the face midline (e.g., the deviation is smaller than a preset value). However, in some cases, this is too costly: on the one hand, the whole dentition needs to be repositioned; on the other hand, the neutral relationship of the upper jaw molars and lower jaw molars might be affected. Therefore, a tradeoff is needed.

It is understood that the above tooth pose adjustments might affect one another/be associated with one another, for example, the adjustment of the midlines of the teeth might require adjustment of the positions of all teeth in a quadrant, which might affect the positional relationship of the upper jaw molars and lower jaw molars along the proximal-distal direction.

Desirably, the “optimal” adjustment solution is a solution, which is easiest to implement and has a minimum adjustment amount, which solution is calculated based on the priority levels of adjustment targets (e.g., the priority level of the alignment of the teeth midlines with the face midline may be reduced compared with the molar neutral relationship), degrees of difficulty of the adjustment items (e.g., the difficulty of adjusting the poses teeth #6 and teeth #7 is higher than that of other teeth, so it is desirable to minimize the adjustment amounts of teeth #6 and teeth #7), and a total adjustment amount (it is desirable to minimize the total adjustment amount). Therefore, an energy equation may be established on this basis, and a solution with a minimum energy calculated based on the equation may be taken as the optimal solution.

In one embodiment, a set of parameters may be used to describe a solution for repositioning the separately-aligned upper jaw teeth and lower jaw teeth to the target tooth arrangement. The value of each variable in the set of parameters may be any real number. The set of parameters is represented by C which may be expressed by the following Equation (1):

C={mᵢ,aᵤ,a_{w},sᵤ,s_{w}|mᵢ∈R,aᵤ∈R,a_{w}∈R,sᵤ∈R,s_{w}∈R} Equation (1)

In one embodiment, the upper jaw teeth and lower jaw teeth are divided into four quadrants. In a case without any missing tooth, each quadrant has teeth #1-#7, which correspond to seven teeth from the central incisor to the last molar, respectively.
mᵢ stands for adjustment amount of the molars along the proximal-distal direction in quadrant i, and R stands for a real number. Generally, tooth #7 in a same quadrant is adjusted along the proximal-distal direction along with tooth #6. Therefore, the proximal-distal direction adjustment amount of tooth #6 in quadrant i may be taken as mᵢ, where i∈{1,2,3,4}.
a stands for the adjustment amount of positions of the incisal edges of the incisors, and the value of a is the distance between the vertices of the two dental arch curves before and after the adjustment. The subscript u stands for the upper jaw, and subscript w stands for the lower jaw.
s stands for a deviation between a teeth midline and the face midline.

It is understood that the parameter set C in the above embodiment is not a complete adjustment solution, and it only comprises variables needed to establish the energy function.

Then, the energy function may be established, and a set of parameters with the minimum energy may be calculated using the energy function as an optimal solution for repositioning the separately-aligned upper jaw teeth and lower jaw teeth to the target tooth arrangement.

A parameterization equation (a part constituting the energy function) may be first created to create the energy function. In one embodiment, the parameterization equation may be created by the following method.

A function relationship between the torque t and the adjustment amount (i.e., sagittal adjustment amount) a of the positions of the incisal edges of the upper incisor and lower incisors may be first created. For a given value of a, the value of the corresponding t may be calculated by the following method: translating the incisors proximally or distally after being aligned, so that the incisal edges are located at the position a, and then rotating the incisors about the incising end points.

A thin plate spline function presented by Equation (2) is obtained by first sampling 100 values of a (denoted as {a₀, a₁, . . . a₉₉} and calculating values of t corresponding to the values of a (denoted as {t₀, t₁, . . . t₉₉}), and then calculating based on the corresponding relationships between the 100 sets of a-to-t parameters:

t=τ(a) Equation (2)

There are the following equations for the upper jaw and lower jaw, respectively:

tᵤ=τᵤ(aᵤ) Equation (3)

t_{w}=τ_{w}(a_{w}) Equation (4)

Then, equations φₘᵢ and φ_{di} of the minimum proximal-distal adjustment amount Bₘᵢ and the maximum proximal-distal adjustment amount B_{di} of the molars in the four quadrants in relation to the adjustment amount (aᵤ, a_{w}) of the positions of the incisal edges of the incisors and the adjustment amount (sᵤ, s_{w}) of the positions of the teeth midline may be created, wherein the subscript m stands for a minimal distal translation amount, and the subscript d stands for a maximum distal translation amount.

Bₘ₁=φₘ₁(aᵤ,sᵤ) Equation (5)

B_{d1}=φ_{d1}(a_{w},sᵤ) Equation (6)

Bₘ₂=φₘ₂(aᵤ,sᵤ) Equation (7)

B_{d2}=φ_{d2}(aᵤ,sᵤ) Equation (8)

Bₘ₃=φₘ₃(a_{w},s_{w}) Equation (9)

B_{d3}=φ_{d3}(a_{w},s_{w}) Equation (10)

Bₘ₄=φₘ₄(a_{w},s_{w}) Equation (11)

B_{d4}=φ_{d4}(a_{w},s_{w}) Equation (12)

10 values of s (denoted as {s₀, s₁, . . . s₉}) are sampled and combined with the 100 values of a to obtain 1000 combination values. Each of the combination values is used to adjust the teeth, i.e., after the incisal edge of the incisor is repositioned to a, and then move the midline by s. Then, the values of the torques of the anterior teeth are calculated using the function t=τ(a), and the torques are adjusted to the values.

Then, collision between each pair of neighboring teeth between teeth #5-#5 is first set to 0.5, and an deviation amount Bₘ of tooth #6 in each quadrant in a direction tangential to the dental arch curve relative to its initial position is recorded. Then, collision between each pair of neighboring teeth between teeth #5-#5 is set to 0, and an deviation amount B_{d} of tooth #6 in each quadrant in the direction tangential to the dental arch curve relative to its initial position is recorded.

As such, 1000 sets of {a, s}-->Bₘ and {a, s}-->B_{d} are obtained for each quadrant. Then, corresponding continuously differentiable thin plate spline functions φₘ and φ_{d} are created for each quadrant.

Then, equations expressed by the following Equations (13) and (14) of left and right molar neutral relationship deviation amounts (Nₗ, Nᵣ) in relation to the adjustment amounts along proximal-distal direction of the upper jaw molars and lower jaw molars on the same side are created:

Nₗ= [symbol] ₗ(m₂,m₃) Equation (13)

Nᵣ= [symbol] ᵣ(m₁,m₄) Equation (14)

Then, tooth #6 on the lower jaw is repositioned to its initial position, and upper jaw tooth #5 is repositioned such that the cusp of the tooth #5 is aligned with the proximal end of the lower jaw tooth #6, and then the upper jaw tooth #6 is repositioned such that it is tightly aligned with tooth #5 (the value of collision is 0), a difference value mₙ between the position of the upper jaw tooth #6 at this time and its initial position is recorded, and the difference values on the left and right sides are denoted as mₙₗ and mₙᵣ, respectively, and then the following equations are obtained:

[symbol]

ₗ(m₂,m₃)=m₂−m₃−mₙₗ Equation (15)

[symbol]

ᵣ(m₁,m₄)=m₁−m₄−mₙᵣ Equation (16)

After the above parameterization equations are created, the energy function may be created based on these parameterization equations. The energy function reflects the mutual influences between the adjustment items (i.e., the adjustment of positions of the incisal edges of the upper jaw incisors and lower jaw incisors, the adjustment of the midline positions of the upper jaw teeth and lower jaw teeth, and the adjustment of the positions of the molars along proximal-distal direction in the four quadrants). An adjustment solution with the minimum energy in a parameter space (i.e., a value space of the adjustment items) calculated using the energy function represents an adjustment solution which is easiest to implement and has the minimum adjustment amount on the premise of meeting the requirements of orthodontic treatment.

In one embodiment, the energy function may be expressed by the following Equation (17):

$$ξ ( c ) = {\sum }_{i = 1}^{4} {L}_{1} ( {B}_{i} ( c ) ) + {\sum }_{i = 1}^{4} {L}_{2} ( {M}_{i} ( c ) ) + {L}_{3} ( {A}_{u} ( c ) ) + {L}_{3} ( {A}_{w} ( c ) ) + {L}_{4} ( O ( c ) ) + {g}_{1} {L}_{5} ( {N}_{l} ( c ) ) + {g}_{2} {L}_{5} ( {N}_{r} ( c ) ) + {L}_{6} ( {S}_{u} ( c ) ) + {L}_{6} ( {S}_{w} ( c ) ) \qquad Equation ( 17 )$$

$$wherein ,$$

$${B}_{i} ( c ) = \{ \begin{matrix}{m}_{i} - {φ}_{mi} if {m}_{i} < {φ}_{mi} \\ 0 if {m}_{i} \leq {φ}_{di} and {m}_{i} \geq {φ}_{mi} \\ {m}_{i} - {φ}_{di} if {m}_{i} > {φ}_{di}\end{matrix} \qquad Equation ( 18 )$$

$${M}_{i} ( c ) = {m}_{i} \qquad Equation ( 19 )$$

$${A}_{u} ( c ) = {a}_{u} - {a}_{ur} \qquad Equation ( 20 )$$

$${A}_{w} ( c ) = {a}_{w} - {a}_{wr} \qquad Equation ( 21 )$$

$$O ( c ) = \{ \begin{matrix}( {a}_{u} - {a}_{w} ) - ( {o}_{ori} - {o}_{std} ) if ( {a}_{u} - {a}_{w} ) > ( {o}_{ori} - {o}_{std} ) \\ 0 if ( {a}_{u} - {a}_{w} ) \leq ( {o}_{ori} - {o}_{std} )\end{matrix} \qquad Equation ( 22 )$$

$${S}_{u} ( c ) = {s}_{u} \qquad Equation ( 23 )$$

$${S}_{w} ( c ) = {s}_{w} \qquad Equation ( 24 )$$

$${N}_{l} ( c ) = {γ}_{l} ( {m}_{2} , {m}_{3} ) \qquad Equation ( 25 )$$

$${N}_{r} ( c ) = {γ}_{r} ( {m}_{1} , {m}_{4} ) \qquad Equation ( 26 )$$

$${L}_{1} ( x ) = 5 \vert x \vert + 5 {x}^{2} \qquad Equation ( 27 )$$

$${L}_{2} ( x ) = 0.2 \vert x \vert \qquad Equation ( 28 )$$

$${L}_{3} ( x ) = 0.1 \vert x \vert \qquad Equation ( 29 )$$

$${L}_{4} ( x ) = 5 \vert x \vert + 5 {x}^{2} \qquad Equation ( 30 )$$

$${L}_{4} ( x ) = 0.05 \vert x \vert \qquad Equation ( 31 )$$

$${L}_{6} ( x ) = 0.05 \vert x \vert \qquad Equation ( 32 )$$

$${g}_{1} = \{ \begin{matrix}0 , & if {m}_{2} \times {m}_{3} > 0 ; \\ 1 , & otherwise .\end{matrix} \qquad Equation ( 33 )$$

$${g}_{2} = \{ \begin{matrix}0 , & if {m}_{1} \times {m}_{4} > 0 ; \\ 1 , & otherwise .\end{matrix} \qquad Equation ( 34 )$$

wherein aᵤᵣ, a_{wr} respectively stand for the positions of the incisal edges when the roots of the upper jaw anterior teeth and lower jaw anterior teeth are at the initial positions, oₒᵣᵢ stands for a overjet value at the initial tooth arrangement, and o_{std} stands for a standard overjet value.

After the energy function is created, a set of parameters representing the optimal solution may be found in the parameter space using the energy function. Then, the separately aligned upper jaw teeth and lower jaw teeth may be repositioned to the target tooth arrangement using the optimal solution.

After the upper jaw teeth and lower jaw teeth are repositioned to the target tooth arrangement using the above method, the collisions/gaps between various pairs of neighboring teeth might be uneven, and the positional relationship between the upper jaw canines and lower jaw canines might not meet the neutral relationship requirement. At this time, enamel reduction/gap may be adjusted by the following method, the 3D tooth digital model at the target tooth arrangement may be further fine-tuned to make the tooth arrangement more optimized.

First, for a quadrant, enamel reduction/gap is evenly allocated to each tooth pair, and calculate the positional relationships between the upper jaw canines and lower jaw canines at this time (substrate the projected positions of the upper jaw canines on the dental arch curve by corresponding projected positions of the gaps between lower jaw canines and teeth #4). The enamel reduction/gap amounts of the proximal tooth pairs (namely, the tooth pairs 1-1, 1-2 and 2-3) and distal tooth pairs of upper jaw canines (namely, the tooth pairs 3-4, 4-5) are firstly adjusted to change the projected positions of the upper jaw canines on the dental arch curve so that the projection of the upper jaw canines coincides with the projections of the adjoining positions of the lower jaw canines and the teeth #4. If the two projections cannot coincide through the allocation and adjustment of the enamel reduction/gap of the upper jaw, the allocation of enamel reduction/gap to the proximal tooth pairs and distal tooth pairs of the lower jaw canines and the teeth #4 is adjusted so that the projection of the adjoining positions of the lower jaw canines and teeth #4 coincide with projections of the upper jaw canines.

Meanwhile, the occlusal collision depth of the upper jaw posterior teeth and lower jaw posterior teeth may be fine-tuned for example by raising or lowering the teeth to control the collision amounts between the upper jaw teeth and lower jaw teeth such that they are within a range of 0-0.5 mm.

While various aspects and embodiments have been disclosed herein, other aspects and embodiments will be apparent to those skilled in the art, inspired by the present application. The various aspects and embodiments disclosed herein are for illustration only and are not intended to be limiting, and the scope and spirit of the present application shall be defined by the following claims.

Likewise, the various diagrams may depict exemplary architectures or other configurations of the disclosed methods and systems, which are helpful for understanding the features and functions that can be included in the disclosed methods and systems. The claimed invention is not restricted to the illustrated exemplary architectures or configurations, and desired features can be achieved using a variety of alternative architectures and configurations. Additionally, with regard to flow diagrams, functional descriptions and method claims, the order in which the blocks are presented herein shall not mandate that various embodiments of the functions shall be implemented in the same order unless otherwise the context specifies.

Unless otherwise specifically specified, terms and phrases used herein are generally intended as “open” terms instead of limiting. In some embodiments, use of phrases such as “one or more”, “at least” and “but not limited to” should not be construed to imply that the parts of the present application that do not use similar phrases intend to be limiting.

We claim:

1. A computer-implemented method for generating a digital dataset representing a target tooth arrangement, comprising:
obtaining a 3D digital model of upper jaw teeth and lower jaw teeth at an initial tooth arrangement;
preliminarily aligning the upper jaw teeth and lower jaw teeth separately according to given indices;
calculating an optimal target tooth arrangement using an energy function based on the preliminarily aligned upper jaw teeth and lower jaw teeth.

2. The computer-implemented method for generating a digital dataset representing a target tooth arrangement of claim 1, wherein the target tooth arrangement is a tooth arrangement to be achieved by an orthodontic treatment.

3. The computer-implemented method for generating a digital dataset representing a target tooth arrangement of claim 1, wherein the given indices comprise two dental arch curves respectively calculated based on the upper jaw teeth and lower jaw teeth at the initial tooth arrangement, and the preliminary alignment comprises arranging the upper jaw teeth and lower jaw teeth according to the two dental arch curves so that FA feature points of the teeth are located on corresponding dental arch curves.

4. The computer-implemented method for generating a digital dataset representing a target tooth arrangement of claim 3, wherein the preliminary alignment further comprises repositioning the upper jaw teeth and lower jaw teeth arranged according to the dental arch curves such that torques and angulations of corresponding teeth are in the same directions.

5. The computer-implemented method for generating a digital dataset representing a target tooth arrangement of claim 4, wherein the given indices further comprise left and right Spee curves calculated based on the upper jaw teeth and lower jaw teeth at the initial tooth arrangement, and the preliminary alignment further comprises adjusting heights of posterior teeth of the upper jaw and lower jaw whose torques and angulations are adjusted, according to the Spee curves.

6. The computer-implemented method for generating a digital dataset representing a target tooth arrangement of claim 4, wherein the given indices further comprise heights of upper jaw incisors and lower jaw incisors calculated based on the upper jaw teeth and lower jaw teeth whose torques and angulations are adjusted, and the preliminary alignment further comprises adjusting the heights of the incisors of the upper jaw and lower jaw according to the calculated heights of the incisors.

7. The computer-implemented method for generating a digital dataset representing a target tooth arrangement of claim 3, wherein the dental arch curves are such that cutting ridges of lower jaw molars arranged according to the dental arch curves are substantially located in central grooves of upper jaw molars.

8. The computer-implemented method for generating a digital dataset representing a target tooth arrangement of claim 1, wherein the energy function is such that the target tooth arrangement meets requirements of an orthodontic treatment on the following aspects: occlusion coverage of anterior teeth, molar neutral relationship, and relationship between teeth midlines and a face midline.

9. The computer-implemented method for generating a digital dataset representing a target tooth arrangement of claim 1, wherein the optimal target tooth arrangement is calculated using the energy function based on priorities of adjustment targets, degrees of difficulty of repositioning different teeth, and a total adjustment amount.

10. The computer-implemented method for generating a digital dataset representing a target tooth arrangement of claim 1, wherein the computer-implemented method further comprises: repositioning the preliminarily aligned upper jaw teeth and lower jaw teeth to the optimal target tooth arrangement.

11. The computer-implemented method for generating a digital dataset representing a target tooth arrangement of claim 10, wherein the computer-implemented method further comprises: allocating enamel reductions and/or gaps to the upper jaw teeth and lower jaw teeth at the target tooth arrangement.

12. The computer-implemented method for generating a digital dataset representing a target tooth arrangement of claim 10, wherein the computer-implemented method further comprises: adjusting occlusion depths of the upper jaw teeth and lower jaw teeth at the target tooth arrangement.
